(19) United States
(12) Patent Application Publication
(10) Pub. No.: US 2009/0164366 A1
(43) Pub. Date: Jun. 25, 2009

(54) PAYMENT VOUCHER GENERATION FOR FINANCIAL TRANSACTIONS

(75) Inventor: Simon Blythe, Cambridgeshire (GB)

Correspondence Address: HOFFMANN & BARON, LLP, 6900 JERICHO TURNPIKE, SYOSSET, NY, 11791, US

(73) Assignee: MASTERCARD INTERNATIONAL, INC., Purchase, NY (US)

(21) Appl. No.: 11/963,268

(22) Filed: Dec. 21, 2007

(51) Int. Cl. G06Q 40/00

(52) U.S. Cl. 705/39

(57) ABSTRACT

The preferred embodiments of the present invention are directed to consummating a financial transaction using payments vouchers. A merchant code associated with a merchant is received by a financial institution terminal, which verifies the merchant code against a stored code. A payment voucher is generated in response to the verification. The voucher includes an encoded message that indicates the voucher is authentic.

### BACKGROUND

In recent years, non-cash transactions have become a preferred method of payment for consumers. Such transactions can use transaction devices, such as credit cards or debit cards, which have consumer account information. Merchants typical use a merchant terminal to read or enter the account information prior to a sale for verification. Once the account information is verified the sale is consummated. Credit accounts allow consumers to engage in financial transactions with a participating merchant without a present requirement of money from the consumer. In a typical credit account transaction, the participating merchant receives payment from a financial institution that has agreed to allow the consumer to make purchases on credit with the promise to pay the financial institution the purchase amount plus some calculated interest at a later time. Debit accounts function in a similar manner as credit accounts, but instead of drawing on credit, the consumer draws against money deposited with a financial institution, usually a financial institution with which the consumer has a bank account. Some merchants, however, are not equipped to or prefer not to accept these payment methods and only accept cash, checks, traveler's checks, money orders, or the like.

Consumers wishing to purchase goods or services from these merchants with, for example, a credit card are denied the purchase and must use another method of payment. This can be burdensome to consumers who may not carry multiple methods of payment. In addition, some financial institutions provide consumers incentives for using their accounts, such as a rewards program, which may make the consumer more inclined to purchase the goods or service from a merchant that accepts the method of payment that the consumer wishes to use. This can be frustrating to consumers and may result in a loss of business for the merchant.

What is needed is a new method of payment that allows a consumer make purchases that does not require merchants to be equipped with a terminal for reading or entering the consumer account information and that does not require consumers to carry multiple methods of payment.

### SUMMARY OF THE INVENTION

Preferred embodiments of the present invention are directed to a payment voucher that can be generated by a financial institution terminal. A voucher generator can generate payment vouchers based on information received from the consumer and/or a merchant. The information received by the voucher generator can include a merchant code, purchase price, purchase category, merchant location, consumer account information, and the like. The voucher generator can validate the information prior to generating the payment voucher and can allow the merchant to verify that the payment voucher is authentic prior to consummating the financial transaction.

In one embodiment, a method of providing a payment voucher for use in a financial transaction is disclosed. The method includes receiving a merchant code associated with a merchant and verifying the merchant code against a stored code. The merchant code can be specified by the merchant or by a selected financial institution. The method further includes generating a payment voucher based on the verification. The voucher includes an encoded message that indicates payment voucher authenticity.

In another embodiment, a computer readable medium that includes instructions executable by a computing device for providing a payment voucher for use in a financial transaction is disclosed. The instructions implement a financial transaction by verifying a merchant code associated with a merchant against a stored code and generating a payment voucher in response to the verification. The payment voucher includes an encoded message that indicates payment voucher authenticity.

In yet another embodiment, a system for implementing a financial transaction is disclosed. The system includes a financial institution terminal. The financial institution terminal receives a merchant code associated with a merchant, verifies the merchant code against a stored code, and generates a voucher in response to the verification. The voucher includes an encoded message that indicates the voucher is authentic. The system can also include a database that stores the stored code and an electronic transaction device associated with a consumer for entering the merchant code. The electronic transaction device communicatively couples to the financial institution terminal to transmit the merchant code to the financial terminal. The financial institution terminal can transmits the voucher to the electronic transaction device to identify to the merchant that the voucher is authentic.

Other objects and features of the present invention will become apparent from the following detailed description considered in conjunction with the accompanying drawings. It is to be understood, however, that the drawings are designed as an illustration only and not as a definition of the limits of the invention.

### BRIEF DESCRIPTION OF THE DRAWINGS

FIG. 1 depicts a financial transaction system in accordance with the preferred embodiments of the present invention;

FIG. 2 is a flow chart that illustrates generation of a voucher using a preferred embodiment of a voucher generator;

FIG. 3 depicts an exemplary financial institution terminal for implementing a voucher generator in accordance with the preferred embodiment of the present invention;

FIG. 4 depicts an exemplary merchant code for use in generating a voucher; and

FIG. 5 depicts an exemplary voucher generated in accordance with the preferred embodiments of the present invention.

### DETAILED DESCRIPTION OF THE PREFERRED EMBODIMENTS

Preferred embodiments of the present invention are directed to a payment voucher that can be generated to allow a consumer to purchase goods or services from a merchant that is not equipped with a terminal to read or enter account information from a transaction device, such as a credit card, debit card or the like. A voucher generator can generate payment vouchers based on information received from the consumer and/or a merchant. The information received by the voucher generator can include a merchant code, purchase price, purchase category, merchant location, consumer account information, and the like. The voucher generator can validate the information prior to generating the payment voucher and can allow the merchant to verify that the payment voucher is authentic prior to consummating the financial transaction.

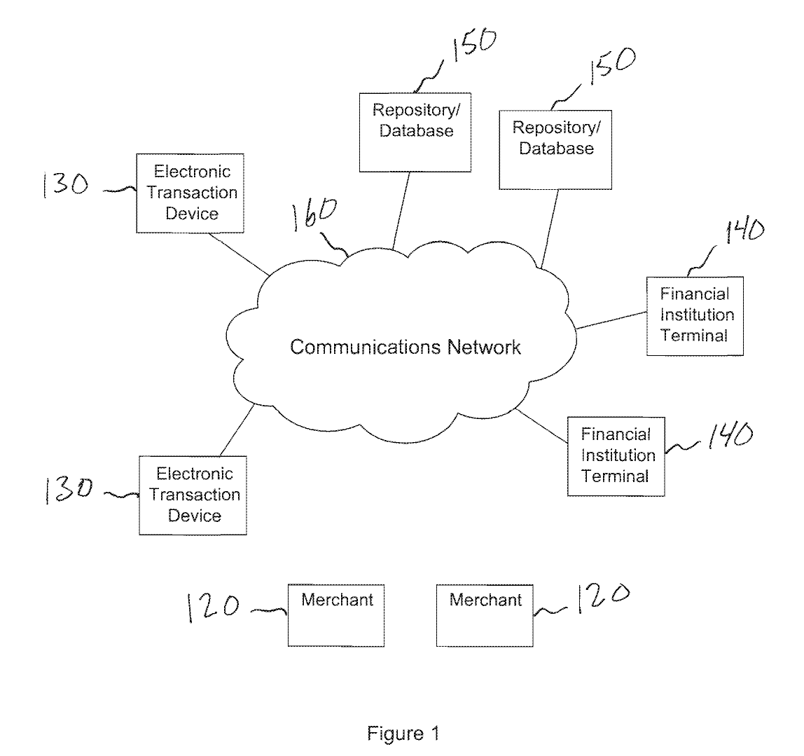

FIG. 1 depicts a financial transaction system that preferably includes merchants 120, electronic transaction device(s) 130 associated with one or more consumers, one or more financial institution terminals 140, one or more databases/repositories 150 (hereinafter “database 150”) and communication network 160, such as a public switched telephone network (PSTN), virtual private network (VPN), Internet, or the like. The merchants 120 do not have terminals for reading or entering consumer account information from a transaction device or are otherwise not equipped to accept credit cards, debit cards, or the like as a method of payment. The merchants 120 may be, for example, in a remote region or may simply prefer not to accept such methods of payment.

The one or more electronic transaction devices 130 are portable computing devices, such as a cell phones, a laptops, PDAs, global positioning (GPS) devices, MP3 players, or the like that are capable of communicating with other device over the communication network 160. The consumer and/or the merchants 120 can use the electronic transaction device 130 to send information to one or more of the financial institution terminals 140 and/or receive a payment voucher from one or more of the financial institution terminals 140.

The one or more financial institution terminals 140 can receive, collect, and maintain information associate with consumer account holders and merchants 120. Such information can include, but is not limited to a consumer account number, merchant account number, merchant code, address of the consumer, location of the merchant, transaction information for purchases, and the like. The information can be stored local to the financial institution terminal in storage and/or or can be stored remote to the financial institution terminal 140 in the database 150. The financial institution terminal 140 can use this information when generating a payment voucher.

In a financial transaction, the consumer wishes to purchase an item from one of the merchants 120 using an account associated with the financial institution. The merchant 120 can have an associated merchant code that can be statically or dynamically specified. The merchant code, consumer account information, and preferably transaction information, such as a purchase price, can be transmitted to the financial institution terminal 140 via the electronic transaction device 130. The financial institution terminal 140 validates the merchant code and generates a payment voucher in response to the merchant code.

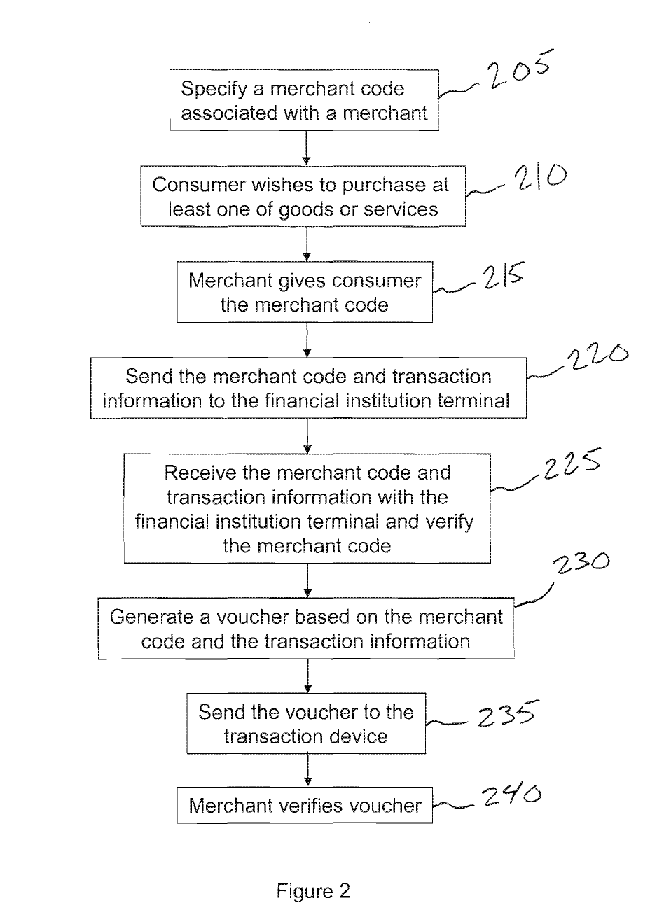

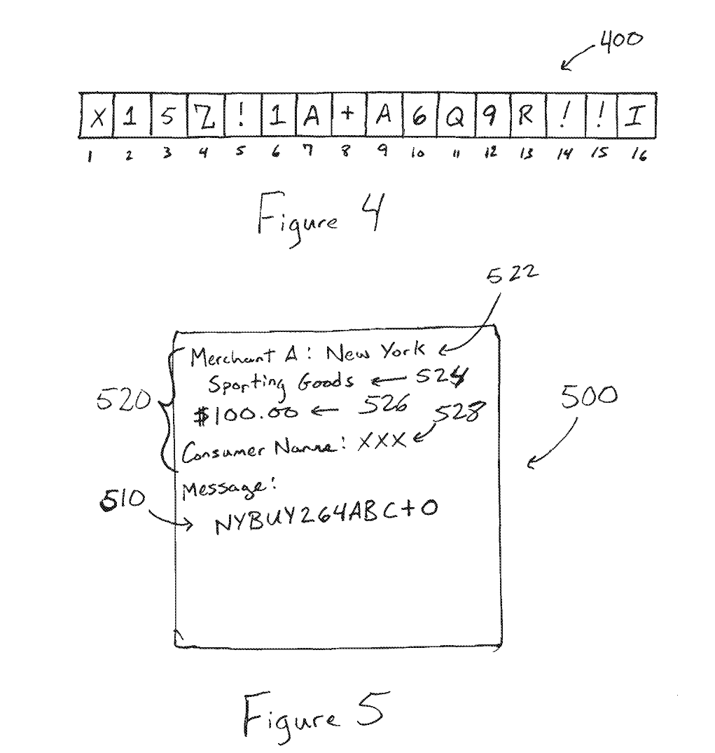

FIG. 2 is a flow chart illustrating the generation of a payment voucher using a voucher generator in accordance with a preferred embodiment of the present invention. A merchant code is specified (step 205). The merchant code can be specified by the merchant 120 or by a financial institution, can include one or more glyphs as described in more detail with respect to FIG. 4, and can be statically or dynamically assigned. Generally, the merchant retains the merchant code until a consumer wishes to purchase a good or service from the merchant 120 using the consumer's account with the financial institution.

When the customer wishes to purchase one or more goods or services using the consumer's account (step 210), the merchant 120 gives the consumer the merchant code (step 215). The consumer can enter the merchant code into the electronic transaction device 130 using a data entry interface associated with the electronic transaction device 130. The data entry interface can be, for example, a keypad, keyboard, or touch screen on a cell phone or portable handheld device. The electronic transaction device 130 sends the merchant code to one or more financial institution terminals 140 via communications network 160 (step 220). In addition, consumer account information and transaction information, such as a purchase price, merchant location, or the like is preferably also sent to the financial institution terminal with the merchant code.

The financial institution terminal 140 verifies the merchant code upon receipt (step 225). To verify the merchant code, the financial institution terminal 140 can compare the merchant code against a merchant code that is stored by the financial institution terminal 140 or by the database 150. The financial institution terminal 140 can also use the additional transaction information sent by the electronic transaction device during the verification. For example, the financial institution terminal 140 can associate the merchant code with a merchant location such that the merchant code and merchant location correspond to one another.

Upon verification by the financial institution terminal 140, the voucher generator generates a voucher in response to the merchant code and the transaction information (step 230). The voucher includes an encoded message that indicates to the merchant that the voucher is authentic. The encoded message can be a message specified by the merchant or can be dynamically specified by the voucher generator. For the case where the encoded message is dynamically generated, the merchant 120 can have a key to decode the dynamically encoded message. The voucher also preferably includes transaction information, such as the purchase amount, merchant location, merchant's name, consumer's name, the number of good(s) or service(s) purchased, and the like. The voucher is discussed in more detail with respect to FIG. 5.

After the voucher is generated, the financial institution terminal 140 sends the voucher to the electronic transaction device 130 (step 235). The merchant verifies that the voucher is authentic based on the encoded message associated with the voucher and the sale can be consummated (step 240). The merchant can verify the voucher via a display on the electronic transaction device 130, such as the display of a cell phone. In the alternative, or in addition, the voucher can be emailed to an email address associated with the merchant, sent to the merchant's cell phone, and/or printed using a printer.

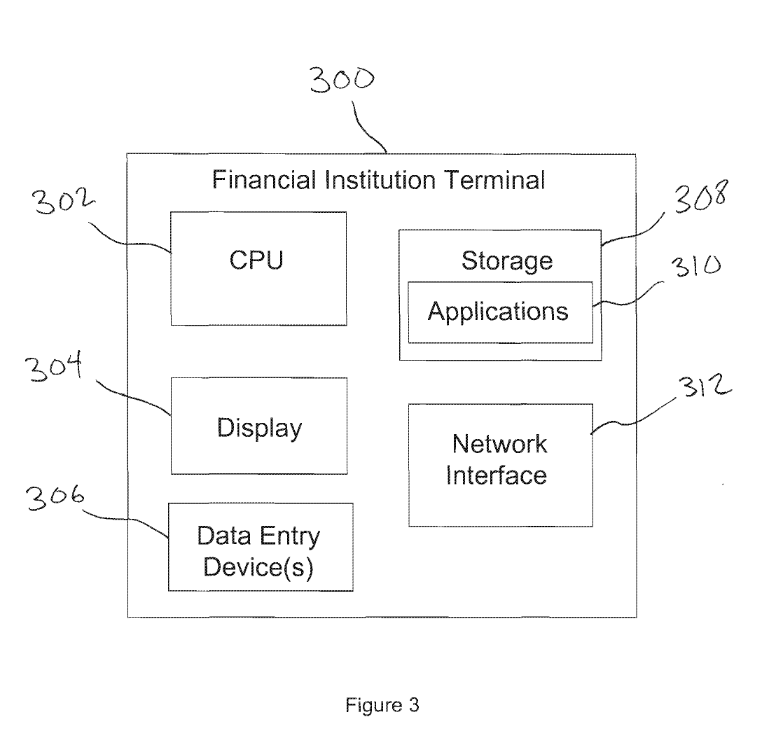

FIG. 3 depicts an exemplary financial institution terminal 140 for implementing the voucher generator in accordance with the preferred embodiment of the present invention. The financial institution terminal 140 can be a mainframe, personal computer (PC), laptop computer, workstation, handheld device, such as a PDA, or the like. In the illustrated embodiment, the financial institution terminal 140 includes a central processing unit (CPU) 302 and preferably a display device 304. The display device 304 enables the financial institution terminal 140 to communicate directly with a user through a visual display. The financial institution terminal 140 can further include data entry device(s) 306, such as a keyboard, touch screen, and/or mouse. The financial institution terminal 140 can include storage 308 for storing data, such as merchant codes, consumer account information, merchant account information, transaction information, and instructions, such as instruction for generating a voucher. The storage 308 can include such technologies as a floppy drive, hard drive, tape drive, Flash drive, optical drive, read only memory (ROM), random access memory (RAM), and the like.

Applications, such as the voucher generator 310 for performing the process described above, can be resident in the storage 308. The storage 308 can be local or remote to the financial institution terminal 140 and can include the database 150. The financial institution terminal 140 includes a network interface 312 for communicating over the communications network 160 to receive information from the electronic transaction devices 130, send payment vouchers to the electronic transaction device or other electronic device, such as an electronic mail server, retrieve information from the database 150, and store information in the database 150. The CPU 302 operates to run the application in storage 308 by performing instructions therein and storing data resulting from the performed instructions, which may be depicted via the display 304 or by other mechanisms known to those skilled in the art, such a print out from a printer.

FIG. 4 depicts an exemplary merchant code 400 that can be sent to the financial institution terminal. The merchant code 400 can include one or more glyphs, such as alpha-numeric characters. In this example, the merchant code includes string of 16 alpha-numeric characters that can be specified by the merchant and/or by the financial institution, however, those skilled in the art will recognize that fewer or more glyphs can be used to implement the merchant code 400. The merchant code 400 can be statically assigned or can be dynamically assigned such that the merchant code 400 changes periodically and can be entered into the electronic transaction device via a data entry interface, such as a keypad, keyboard, touch screen, or the like.

FIG. 5 depicts an exemplary voucher 500 that can is generated by the voucher generator in response to the merchant code. The voucher 500 can include one or more glyphs, such as alpha-numeric characters. The voucher can include an encoded message 510 that only the merchant can decipher. The encoded message 510 can be predetermined or may by generated dynamically when the voucher is generated. For embodiments in which the encoded message 510 is generated dynamically, the merchant can have a key to decode the encoded message 5 10. Using the encoded message 510, the merchant can verify that the voucher 500 is valid prior to consummating the sale. Such an encoded message 500 can be specified by the merchant or the financial institution. The payment voucher also preferably includes transaction information 520, such as a merchant name 522, merchant category 524, purchase price 526, consumer name 528, and the like.

While preferred embodiments of the present invention have been described herein, it is expressly noted that the present invention is not limited to these embodiments, but rather the intention is that additions and modifications to what is expressly described herein are also included within the scope of the invention. Moreover, it is to be understood that the features of the various embodiments described herein are not mutually exclusive and can exist in various combinations and permutations, even if such combinations or permutations are not made express herein, without departing from the spirit and scope of the invention.

What is claimed is:

1. A method of providing a payment voucher for use in a financial transaction comprising:
receiving a merchant code associated with a merchant;
verifying the merchant code against a stored code; and
generating a payment voucher based on the verification, the payment voucher comprising an encoded message that indicates payment voucher authenticity.

2. The method of claim 1, comprising specifying the merchant code by at least one of the merchant and a selected financial institution.

3. The method of claim 1, comprising associating a predefined message specified by the merchant with the encoded message.

4. The method of claim 1, comprising associating a predefined message specified by a selected financial institution with the encoded message.

5. The method of claim 1, comprising specifying dynamically at least one of the merchant code and the encoded message.

6. The method of claim 1, further comprising:
receiving at least one of consumer and transaction information; and
generating the voucher using the at least one consumer and transaction information.

7. The method of claim 1, further comprising conducting a financial transaction using the payment voucher as a medium of exchange.

8. The method of claim 1, comprising forming the merchant code from at least one glyph.

9. A computer readable medium comprising instructions executable by a computing device that, when applied to the computing device, cause the device to:
verify a merchant code associated with a merchant against a stored code in response to receiving the merchant code; and
generate a voucher based on the verification, the payment voucher comprising an encoded message that indicates the payment voucher authenticity.

10. A system for generating a payment voucher for use in a financial transaction comprising:
a financial institution terminal that is configured to receive a merchant code associated with a merchant, verify the merchant code against a stored code, and generate a payment voucher in response to the verification, wherein the payment voucher comprises an encoded message that indicates payment voucher authenticity.

11. The system of claim 10, further comprising a database that stores the stored code, the database being communicatively coupled to the financial institution terminal.

12. The system of claim 10, further comprising a electronic transaction device associated with a consumer for entering the merchant code, the electronic transaction device communicatively coupling to the financial institution terminal to transmit the merchant code to the financial terminal.

13. The system of claim 12, wherein the financial institution terminal transmits the voucher to the electronic transaction device to identify to the merchant that the voucher is authentic.

14. The system of claim 10, wherein at least one of the merchant code or the encoded message are specified dynamically.
